(19) United States
(12) Patent Application Publication
(10) Pub. No.: US 2024/0059615 A1
(43) Pub. Date: Feb. 22, 2024

(54) DIRECT BRUCITE CARBONATION FOR CEMENTATION

(71) Applicant: The Regents of the University of California, Oakland, CA (US)

(72) Inventors: Gaurav N. Sant, Los Angeles, CA (US); Dale Prentice, Los Angeles, CA (US); Dante Adam Simonetti, Los Angeles, CA (US); Jenny Arabit, Los Angeles, CA (US)

(21) Appl. No.: 18/217,171

(22) Filed: Jun. 30, 2023

Related U.S. Application Data
(60) Provisional application No. 63/357,356, filed on Jun. 30, 2022.

(51) Int. Cl. C04B 28/10; C04B 40/02; C04B 40/00

(52) U.S. Cl. CPC C04B 28/10; C04B 40/0231; C04B 40/0082; C04B 40/0281

(57) ABSTRACT

The present disclosure provides methods of preparing concrete products comprising carbonation of brucite-containing concrete. The present disclosure further provides brucite containing concrete mixtures that are useful in the present methods.

### CROSS-REFERENCE TO RELATED APPLICATIONS

This application claims the benefit of priority to U.S. Provisional Application No. 63/357,356, filed Jun. 30, 2022, the contents of which are herein incorporated by reference in their entirety.

### STATEMENT REGARDING FEDERALLY SPONSORED RESEARCH

This invention was made with government support under Grant Number DE-FE0031718, awarded by U.S. Department of Energy and under Grant Number 1922167, awarded by the National Science Foundation. The government has certain rights in the invention.

### BACKGROUND

Conventional concrete production exhibits several problems at large scales. Producing ordinary Portland cement (OPC) via conventional methods is highly energy-intensive, requiring >5000 J/g of energy in the form of heat, and an additional 600 J/g of energy for grinding. This is an untenable energy and CO2 burden for a material that is manufactured at the scale of 4.1 B (in the case of OPC) and >30 B (in the case concrete) tonnes of CO₂ per year, globally. The production and use of OPC is therefore responsible for ≈9% of anthropogenic CO₂ emissions. Accordingly, there is a need for methods of producing cement that reduce reliance on OPC, are more energy efficient, and that use CO₂ emissions and solid wastes from the energy and industry sectors.

### SUMMARY OF THE INVENTION

In some embodiments, the present disclosure provides a method of preparing a concrete product, comprising the following steps:
(a) forming a concrete mixture into a desired shape; and
(b) cementing and carbonating the concrete mixture in contact with a gaseous CO₂ source,
wherein the concrete mixture comprises:
   (i) 5-50% (w/w) of cementitious precursor comprising:
      (a) from about 20% to about 90% (w/w) of a binder comprising brucite and a cement replacement material; and
      (b) from about 5% to about 50% (w/w) Ordinary Portland Cement; and
   (ii) 50-95% (w/w) of filler.

Other embodiments of the present disclosure provide a composition for a concrete mixture comprising
(i) 5-50% (w/w) of cementitious precursor comprising:
   (a) from about 20% to about 90% (w/w) of a binder comprising brucite and a cement replacement material; and
   (b) from about 5% to about 50% (w/w) Ordinary Portland Cement; and
(ii) 50-95% (w/w) of filler.

### BRIEF DESCRIPTION OF THE DRAWINGS

FIG. 1 is a block flow diagram depicting a process for carbonating brucite according to some embodiments of the invention.

### DETAILED DESCRIPTION OF THE INVENTION

The present disclosure provides methods of producing concrete by carbonating brucite. The methods advantageously replace about 50-90% by mass, w/w, of OPC with a binder comprising brucite (Mg(OH)2) and a cement replacement material.

Direct carbonation of brucite provides a uniquely scalable process for CO₂ utilization (CO₂U) that operates at near-ambient temperature/pressure and converts CO₂ from dilute flue gas streams (e.g., flue gas streams containing ≥3% v/v CO₂, such as in flue gases of fossil fuel power plants and industrial emitters) into stable, solid carbonate minerals that fulfill a cementation function [1-3].

The cement products produced by the present methods of the present invention offer functional-, cost- and engineering-compatibility with traditional concrete products. Additionally, the methods may advantageously replace OPC-based concrete, or reduce the amount of OPC used in concrete product, and create a gigaton-scale pathway for CO₂U, while potentially reducing the embodied carbon intensity (eCI) of concrete components by at least 50%. Together, these benefits create an unprecedented opportunity to reduce the CO₂ intensity of the built environment while utilizing CO₂ emissions and solid wastes from the energy and/or industry sectors.

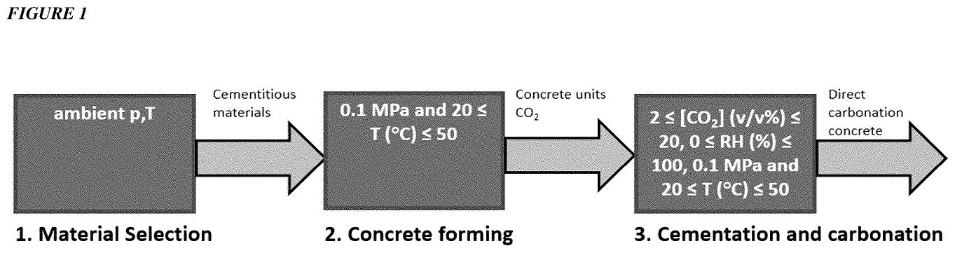

The process described herein (see block flow diagram in FIG. 1) can integrate direct carbonation of brucite into a traditional concrete production plant, to provide masonry concrete units or precast concrete:
1. Material selection: concrete unit types range in cement content depending on the unit type chosen (5-50 mass %) and strength needed for a given application. The present methods and compositions advantageously replace about 50 to about 90 mass % of OPC with a binder comprising brucite (Mg(OH)₂) and a cement replacement material, such as fly ash, slag cement, ground steel slag, or any combination thereof.
2. Concrete formation: the revised concrete mixture design for a given concrete product is mixed and cast into the desired forms. The concrete forming step is similar to traditional methods known to those skilled in the art, reducing the impact on traditional concrete unit production and reducing the cost of retrofitting existing production facilities.
3. Cementation and carbonation: the concrete units cure for a period of time before removal from the concrete forms. The units may then be transported to a custom-built carbonation reactor that is gas-tight to avoid the loss of CO₂ from the reactor during carbonation. Operating conditions affect the cementitious carbonates formed in this stage. Temperature, relative humidity and concentration of CO₂, henceforth [CO₂], may be controlled via a proportional-integral-derivative (PID) controller, e.g., using responsive heaters, condensers, humidifiers and gas flow controllers. Operating conditions may be optimized to provide rapid reaction kinetics and enhance CO₂ uptake, e.g., within the range: 2≤[CO₂] (v/v %)≤20, 10<RH (%)≤100, 0.01-1.0 MPa and 20≤T (° C.)≤50. Carbonation operating times within industry standard production timeframes, as will be understood by those skilled in the art, may be employed. Once the carbonation process is completed, the concrete units may be removed from the forms and stored on-site until the ASTM required strength is achieved.

While not being bound by theory, magnesium hydroxide (“brucite”—Mg(OH)₂) is a useful alternative to OPC for the CO₂ mineralization and cementation process. Carbonation of Mg—derived minerals form magnesium hydrate carbonates (MHCs) at low temperatures and pressures, thereby producing nesquehonite, lansfordite, hydromagnesite, artinite and dypingite as shown in equations 1-5 below: [4]:

Mg(OH)₂+CO₂+2H₂O→MgCO₃·3H₂O(Nesquehonite) (1)

Mg(OH)₂+CO₂+4H₂O→MgCO₃·5H₂O(Lansfordite) (2)

5Mg(OH)₂+4CO₂→4MgCO₃Mg(OH)₂·4H₂O(Hydromagnesite) (3)

2Mg(OH)₂+CO₂+2H₂O→MgCO₃Mg(OH)₂·₃H₂O(Artinite) (4)

5Mg(OH)₂+4CO₂+H₂O→4MgCO₃Mg(OH)₂·5H₂O(Dypingite) (5)

Carbonation of Mg-derived minerals (e.g., brucite and Mg-silicates) has been conducted across a range of operating conditions to produce MHCs listed in equations 1-5 at near ambient conditions (T<70° C. and P=0.1013 MPa) [1,2,4,5]. At near-ambient conditions, existing methods have been shown to produce carbonated Mg-minerals in aqueous solutions [1,4,5]. Additionally, similar methods have used gas-solid interactions (RH<90%) [2] to produce MHCs. These methods have been used to carbonate brucite and Mg-silicates (e.g., olivine—Mg₂SiO₄, serpentine—Mg₂Si₂O₅(OH)₄) to sequester CO₂.

Temperatures and solution composition affect the precipitation phases for Mg-carbonates, but general trends based on the temperature have been identified [6]. At temperatures of 15≤T<70° C., hydromagnesite is the most stable MHC followed by nesquehonite [7,8]. Nesquehonite has higher reaction kinetics compared to hydromagnesite at the lower temperatures within this range (<25° C.) and for higher CO₂ pressures and concentrations, while hydromagnesite forms at the higher temperatures [9-11]. Nesquehonite transforms to hydromagnesite via dypingite [6,12]. At temperatures below 15° C., artinite and lansfordite replace hydromagnesite and nesquehonite, respectively [7,8]. Magnesite (MgCO₃) does not readily form at lower temperatures and pressures (T<70° C. and P=0.1013 MPa) due to the kinetic inhibition derived from the highly hydrated characteristics of Mg²⁺[13] and resulting reduced exchange rate of water between Mg²⁺ and the remaining solution [14]. Higher temperature and pressures (T>70° C., P >0.5 MPa, and 0<RH <100%) produce magnesite in addition to nesquehonite, hydromagnesite and dypingite in under 60 hours of operating times to overcome this Mg²⁺ hydration preference [3,15-19].

The presently disclosed brucite carbonation process provides, in some embodiments, conditions of 2≤[CO₂]≤30 v/v %, 20≤T≤90° C., 10≤RH≤100%, and P≈0.1013 MPa. Accordingly, the proposed process provides low temperature and pressure carbonation, OPC material replacement, and low CO₂ utilization pathways without the need for pre- or post-treatment of material, and further provides simple integration into existing concrete plants. Cemented solids produced by the present methods have lower eCI than conventional cement manufacturing.

Compared to traditional concrete products and production practices, direct brucite carbonation offers a greatly reduced embodied carbon intensity (eCI, kg CO₂e/m³), and improved quality control while offering comparable cost, functional and engineering performance. Significantly, this process addresses the largest opportunity for CO₂ utilization (i.e., construction materials) by exploiting chemical reactions that do not use significant extrinsic energy inputs (i.e., thermodynamically downhill) even while using CO₂-dilute feedstocks (flue gases).

Globally, 27 million tonnes of magnesium compounds are produced annually [20]. The cost of brucite is about 150-500 $/tonne depending on the production method, is generally higher than that of portlandite (˜149 $/tonne) [20]. The lowest price material, caustic calcined magnesia, is more reactive and produces a smaller particle size material which can be used in this process. Full conversion of brucite would yield 0.75 tonneCO₂/tonneBrc as compared to 0.59 tonneCO₂/tonneCH for portlandite. Considering only the material costs of brucite and portlandite, up to 1.5-5.0 kgCO₂/$ and 4.0 kgCO₂/$, respectively, can be sequestered using these starting materials. Brucite offers a potentially high CO₂ uptake (i.e., 0.75 tonneCO₂/tonneBrc) and is currently consumed at a global level of 1 million tonnes per year with 5.7% growth observed annually [21]. Direct brucite carbonation can take advantage of this magnesia production growth and be developed into an attractive CO₂U pathway for producing concrete products.

### Definitions

Unless otherwise defined herein, scientific and technical terms used in this application shall have the meanings that are commonly understood by those of ordinary skill in the art.

All of the above, and any other publications, patents and published patent applications referred to in this application are specifically incorporated by reference herein. In case of conflict, the present specification, including its specific definitions, will control.

As used herein, the terms “optional” or “optionally” mean that the subsequently described event or circumstance may occur or may not occur, and that the description includes instances where the event or circumstance occurs as well as instances in which it does not.

As used herein, the term “concrete mixture” refers to the uncured mixture comprising air, aggregates, water, and a cementitious binder, which upon curing produces the solid building material known in the art as “concrete.”

“Curing” as used herein refers to the process of altering a hydraulic cementitious or concrete mixture by heating the mixture to a “curing temperature”, thereby inducing chemical reaction(s) between any of the components of the mixture and/or the evaporation of water from the mixture to produce a solid, “cured” cement or concrete product.

As used herein, the term “cementitious binder,” “cementitious mixture,” and “cementitious precursor” are used to generally describe any uncured hydraulic binding material that is used in concrete mixtures to produce a stable concrete product upon undergoing a curing process, as is well-known in the art. The term “cement” as used herein refers to the product produced by curing a cementitious precursor, binder or slurry. As a non-limiting example, Ordinary Portland Cement (OPC) or Normal Portland Cement is a common name used to describe a type of cementitious binder (either cured or uncured). OPC comprises essentially a dry component including (i) a “clinker” comprising calcareous materials and argillaceous materials that have been crushed to a desired grain size and heated to induce carbonation, and finely ground gypsum. When this dry component is mixed with a desired amount of water, a “cementitious slurry” or “cementitious precursor” is formed which “sets” upon drying or curing. During the setting or curing process, a complex set of chemical reactions occurs to produce a stable solid known in the art as “cement.”

The term “brucite” as used herein is an art-recognized term which refers generally to the compound Mg(OH)₂, including its naturally occurring mineral forms. In preferred embodiments, brucite refers to any of the naturally occurring mineral materials comprising primarily Mg(OH)₂, also including the fibrous form known commonly as nemalite.

The term “slag” is an art-recognized term which refers to the waste products from ore-smelting operations, including, as a non-limiting example, slags produced during the production of steel (i.e., steel slags).

“Carbonation” as used herein refers to any reaction of a compound or material with CO₂ to form carbon-containing products including, as a non-limiting example, carbonate (CO₃²⁻).

“Admixture” as used herein is an art-recognized term that refers to any additional component(s) added to defined concrete composition as described herein to alter the properties of the concrete composition. As non-limiting examples, common concrete admixture types include proprietary components or blends of components known in the art as water reducing admixtures, retarding admixtures, accelerating admixtures, air entraining concrete admixtures, pozzolanic admixtures, damp-proofing admixtures, gas forming admixtures, air detraining admixtures, alkali aggregate expansion, inhibiting admixtures, anti-washout admixtures, grouting admixtures, corrosion inhibiting admixtures, bonding admixtures, fungicidal, germicidal, and/or insecticidal admixtures, and coloring admixtures.

“Fly ash” and “bottom ash” as used herein are art-recognized terms which refer to certain solid particulate byproducts of industrial coal combustion. These terms as used herein may also refer to any related materials commonly known as, as non-limiting examples, flue ash, coal ash, pulverized fuel ash, or coal combustion residuals.

Methods of Brucite Carbonation

In some embodiments, the present disclosure provides a method of preparing a concrete product, comprising the following steps:
(a) forming a concrete mixture into a desired shape; and
(b) cementing and carbonating the concrete mixture in contact with a gaseous CO₂ source,
wherein the concrete mixture comprises:
   (i) 5-50% (w/w) of a cementitious precursor comprising:
      (a) from about 20% to about 90% (w/w) of a binder comprising brucite and a cement replacement material; and
      (b) from about 5% to about 50% (w/w) of Ordinary Portland Cement; and
   (ii) 50-95% (w/w) of a filler.

In some embodiments, the concrete mixture is cemented and carbonated at a curing temperature from about 20° C. to about 90° C. In other embodiments, the temperature is from about 20° C. to about 80° C., or about 20° C. to about 70° C. In still other embodiments, the temperature is from about 30° C. to about 70° C. In more particular embodiments, the temperature is about 30° C., about 35° C., about 40° C., about 50° C., about 55° C., about 60° C., about 65° C., or about 70° C.

In some embodiments, the CO₂ concentration during cementation and carbonation is from about 2% (v/v) to about 30% (v/v) CO₂. In other embodiments, the CO₂ concentration is from 3% (v/v) to about 25% (v/v), about 3% (v/v) to about 20% (v/v), about 3% (v/v) to about 15% (v/v), about 5% (v/v) to about 25% (v/v), about 5% (v/v) to about 20% (v/v), about 5% (v/v) to about 15% (v/v), or about 5% (v/v) to about 10% (v/v) CO₂. In some embodiments, the CO₂ concentration is about 5% (v/v), about 10% (v/v), about 15% (v/v) CO₂, about 20% (v/v) CO₂, or about 25% (v/v) CO₂.

In some embodiments, relative humidity during cementation and carbonation is from about 10% to about 100%. In some embodiments, the relative humidity is from about 20% to about 90%, about 25% to about 90%, about 30% to about 90%, about 35% to about 90%, about 25% to about 80%, about 30% to about 80%, about 35% to about 80, about 25% to about 70%, about 30% to about 70%, about 35% to about 70%, about 25% to about 60%, about 30% to about 60%, about 35% to about 60%, about 25% to about 50%, about 30% to about 50%, or about 35% to about 50%. In more particular embodiments, the relative humidity is about 20%. In some embodiments, the relative humidity is about 30%. In some embodiments, the relative humidity is about 40%. In some embodiments, the relative humidity is about 50%. In some embodiments, the relative humidity is about 60%. In some embodiments, the relative humidity is about 70%. In some embodiments, the relative humidity is about 80%. In some embodiments, the relative humidity is about 90%.

In some embodiments, the carbonation pressure is from about 0.01 MPa to about 1.0 MPa. In some embodiments, the carbonation pressure is from about 0.01 MPa to about 0.5 MPa, about 0.01 to about 0.3 MPa, and about 0.1 to about 0.2 MPa, or about 0.01 to about 0.1 mPa. In some embodiments, the carbonation pressure is about 0.05 to about 2 MPa, about 0.05 to about 1.5 MPa or about 0.8 to about 1.2 MPa. In some embodiments, the carbonation pressure is about 0.1 mPa, about 0.2 MPa, about 0.3 MPa, about 0.4 MPa, about 0.5 MPa, about 0.6 MPa, about 0.7 MPa, about 0.8 MPa, about 0.9 MPa, or about 1.0 MPa.

In certain preferred embodiments, the CO₂ concentration is from about 3% to about 20% v/v, the temperature is about 20° C. to about 70° C., the relative humidity is about 10 to about 100%, and the pressure is about 0.1 mPa.

In some embodiments, the filler comprises an aggregate material, such as gravel, sand, pebbles, crushed stones, crushed recycled concrete, rocks, slag, bottom ash, or any combination thereof.

In some embodiments, the cement replacement material comprises fly ash, slag cement, recycled cement, ground steel slag, or any combination thereof.

In some embodiments, the concrete mixture further comprises an admixture, where the admixture comprises a water reducing admixture, a retarding admixture, an accelerating admixture, an air entraining concrete admixture, a pozzolanic admixture, a damp-proofing admixture, a gas forming admixture, an air detraining admixture, an alkali aggregate expansion admixture, an inhibiting admixture, an anti-washout admixture, a grouting admixture, a corrosion inhibiting admixture, a bonding admixture, a fungicidal admixture, a germicidal admixture, an insecticidal admixture, a coloring admixture, or any combination thereof.

In some embodiments, the concrete mixture composition comprises about 10% to about 50%, about 10% to about 40%, about 10% to about 30%, about 5 to about 40% or about 5 to about 30% (w/w) of the cementitious precursor. In more particular embodiments, the concrete mixture composition comprises about 5%, about 10%, about 15%, 20%, about 25%, about 30%, about 35%, about 40%, about 45%, or about 50% (w/w) of cementitious precursor.

In certain embodiments, the cementitious precursor comprises about 30% to about 80%.about 40% to about 80%. About 50 to 80%, or about 60% to about 80% (w/w) of the binder. In more particular embodiments, the cementitious precursor comprises about 20%, about 25%, about 30%, about 35%, about 40%, about 45%, about 50%, about 55%, about 60%, about 65%, about 70%, about 75%, about 80%, about 85%, or about 90% (w/w) of the binder.

In certain embodiments, the cementitious precursor comprises from about 30% to about 80%.about 40% to about 80%, about 50 to 80%, or about 60% to about 80% (w/w) of brucite.

In some embodiments, the cementitious precursor comprises about 5% to about 70%, about 5% to about 60%, about 5% to about 50%, about 5% to about 40%, about 5% to about 30%, about 5% to about 20%, or about 5% to about 10% (w/w) OPC. In more particular embodiments, the cementitious precursor comprises about 5%, about 10%, about 15%, about 20%, about 25%, about 30%, about 35%, about 40%, about 45%, about 50%, about 55%, about 60%, about 65%, about 70%, about 75%, or about 80% (w/w) OPC.

In some embodiments, the concrete mixture composition comprises about 50% to about 90%, about 50% to about 80%, about 50% to about 70% or about 50% to about 60% (w/w) of the filler. In more particular embodiments, the concrete mixture composition comprises about 50% about 55%, about 60%, about 65%, about 70%, about 75, about 80%, about 85%, about 90% or about 95% (w/w) of filler.

In some embodiments, the brucite has a purity from about 30% to 90%.

### Concrete Mixture Compositions

Other embodiments of the present disclosure provide a concrete mixture comprising
(i) 5-50% (w/w) of cementitious precursor comprising:
   (a) from about 20% to about 90% (w/w) of a binder comprising brucite and a cement replacement material; and
   (b) from about 5% to about 50% (w/w) Ordinary Portland Cement; and
(ii) 50-95% (w/w) of filler.

In some embodiments, the filler comprises an aggregate material, such as gravel, sand, pebbles, crushed stones, crushed recycled concrete, rocks, slag, bottom ash, or any combination thereof.

In some embodiments, the cement replacement material comprises fly ash, slag cement, recycled cement, ground steel slag, or any combination thereof.

In some embodiments, the concrete mixture further comprises an admixture, where the admixture comprises a water reducing admixture, a retarding admixture, an accelerating admixture, an air entraining concrete admixture, a pozzolanic admixture, a damp-proofing admixture, a gas forming admixture, an air detraining admixture, an alkali aggregate expansion admixture, an inhibiting admixture, an anti-washout admixture, a grouting admixture, a corrosion inhibiting admixture, a bonding admixture, a fungicidal admixture, a germicidal admixture, an insecticidal admixture, a coloring admixture, or any combination thereof.

In some embodiments, the concrete mixture composition comprises about 10% to about 50%, about 10% to about 40%, about 10% to about 30%, about 5 to about 40% or about 5 to about 30% (w/w) of the cementitious precursor. In more particular embodiments, the concrete mixture composition comprises about 5%, about 10%, about 15%, 20%, about 25%, about 30%, about 35%, about 40%, about 45%, or about 50% (w/w) of cementitious precursor.

In certain embodiments, the cementitious precursor comprises about 30% to about 80%.about 40% to about 80%. About 50 to 80%, or about 60% to about 80% (w/w) of the binder. In more particular embodiments, the cementitious precursor comprises about 20%, about 25%, about 30%, about 35%, about 40%, about 45%, about 50%, about 55%, about 60%, about 65%, about 70%, about 75%, about 80%, about 85%, or about 90% (w/w) of the binder.

In certain embodiments, the cementitious precursor comprises from about 30% to about 80%.about 40% to about 80%, about 50 to 80%, or about 60% to about 80% (w/w) of brucite.

In some embodiments, the cementitious precursor comprises about 5% to about 70%, about 5% to about 60%, about 5% to about 50%, about 5% to about 40%, about 5% to about 30%, about 5% to about 20%, or about 5% to about 10% (w/w) OPC. In more particular embodiments, the cementitious precursor comprises about 5%, about 10%, about 15%, about 20%, about 25%, about 30%, about 35%, about 40%, about 45%, about 50%, about 55%, about 60%, about 65%, about 70%, about 75%, or about 80% (w/w) OPC.

In some embodiments, the concrete mixture composition comprises about 50% to about 90%, about 50% to about 80%, about 50% to about 70% or about 50% to about 60% (w/w) of the filler. In more particular embodiments, the concrete mixture composition comprises about 50% about 55%, about 60%, about 65%, about 70%, about 75, about 80%, about 85%, about 90% or about 95% (w/w) of filler.

In some embodiments, the brucite has a purity from about 30% to 90%.

### REFERENCES

[1] H. Nguyen, H. Santos, H. Sreenivasan, W. Kunther, V. Carvelli, M. Illikainen, P. Kinnunen, On the carbonation of brucite: Effects of Mg-acetate on the precipitation of hydrated magnesium carbonates in aqueous environment, Cem. Concr. Res. 153 (2022) 106696. https://doi.org/10.1016/j.cemconres.2021.106696.
[2] K. Rausis, A. Ćwik, I. Casanova, Phase evolution during accelerated CO₂ mineralization of brucite under concentrated CO₂ and simulated flue gas conditions, J. CO₂ Util. 37 (2020) 122-133. https://doi.org/10.1016/j.jcou.2019.12.007.
[3] K. Rausis, A. Ćwik, Direct moist carbonation of brucite-rich serpentinized dunites: An alternative to the carbonation of heat-activated serpentine, Appl. Geochem. 127 (2021) 104851. https://doi.org/10.1016/j.apgeochem.2020.104851.
[4] I. Singh, R. Hay, K. Celik, Recovery and direct carbonation of brucite from desalination reject brine for use as a construction material, Cem. Concr. Res. 152 (2022) 106673. https://doi.org/10.1016/j.cemconres.2021.106673.
[5] C. C. Turvey, S. A. Wilson, J. L. Hamilton, A. W. Tait, J. McCutcheon, A. Beinlich, S. J. Fallon, G. M. Dipple, G. Southam, Hydrotalcites and hydrated Mg-carbonates as carbon sinks in serpentinite mineral wastes from the Woodsreef chrysotile mine, New South Wales, Australia: Controls on carbonate mineralogy and efficiency of CO₂ air capture in mine tailings, Int. J. Greenh. Gas Control. 79 (2018) 38-60. https://doi.org/10.1016/j.ijggc.2018.09.015.
[6] L. Hopkinson, P. Kristova, K. Rutt, G. Cressey, Phase transitions in the system MgO—CO2— H₂O during CO₂ degassing of Mg-bearing solutions, Geochirn. Cosrnochirn. Acta. 76 (2012) 1-13. https://doi.org/10.1016/j.gca.2011.10.023.
[7] G. M. Marion, Carbonate mineral solubility at low temperatures in the Na—K—Mg—Ca—H—Cl—SO04—OH—HCO3-CO3—CO2—H₂O system, Geochirn. Cosrnochirn. Acta. 65 (2001) 1883-1896. https://doi.org/10.1016/S0016-7037(00)00588-3.
[8] E. Königsberger, L.-C. Konigsberger, H. Gamsjager, Low-temperature thermodynamic model for the system Na2CO3—MgCO₃—CaCO3—H₂O, Geochirn. Cosrnochirn. Acta. 63 (1999) 3105-3119. https://doi.org/10.1016/S0016-7037(99)00238-0.
[9] X. P. Wang, J. J. Yu, J. Cheng, Z. P. Hao, Z. P. Xu, High-Temperature Adsorption of Carbon Dioxide on Mixed Oxides Derived from Hydrotalcite-Like Compounds, Environ. Sci. Technol. 42 (2008) 614-618. https://doi.org/10.1021/es072085a.
[10] W. Cheng, Z. Li, G. P. Demopoulos, Effects of Temperature on the Preparation of Magnesium Carbonate Hydrates by Reaction of MgCl2 with Na₂CO3, Chin. J. Chem. Eng. 17 (2009) 661-666. https://doi.org/10.1016/S1004-9541(08)60260-8.
[11] Q. Gautier, P. Bénezeth, V. Mavromatis, J. Schott, Hydromagnesite solubility product and growth kinetics in aqueous solution from 25 to 75° C., Geochirn. Cosrnochirn. Acta. 138 (2014) 1-20. https://doi.org/10.1016/j.gca.2014.03.044.
[12] L. Hopkinson, K. Rutt, G. Cressey, The Transformation of Nesquehonite to Hydromagnesite in the System CaO—MgO—H 2 0—CO 2: An Experimental Spectroscopic Study, J. Geol. 116 (2008) 387-400. https://doi.org/10.1086/588834.
[13] Sayles, F. L., Fyfe, W. S., The crystallization of magnesite from aqueous solution, Geochim. Cosmochim. Acta. 37 (1973) 87-99.
[14] A. Bleuzen, P. -A. Pittet, L. Helm, A. E. Merbach, Water exchange on magnesium(II) in aqueous solution: a variable temperature and pressure170 NMR study, Magn. Reson. Chem. 35 (1997) 765-773. haps://doi.org/10.1002/(SICI)1097-458X(199711)35:11<765:AID-OMR169>3 0.CO;2-F.
[15] H. T. Schaef, C. F. Windisch, B. P. McGrail, P. F. Martin, K. M. Rosso, Brucite [Mg(OH2)] carbonation in wet supercritical CO₂: An in situ high pressure X-ray diffraction study, Geochim. Cosmochim. Acta. 75 (2011) 7458-7471. https://doi.org/10.1016/j.gca.2011.09.029.
[16] K. Rausis, A. Ćwik, I. Casanova, Insights into the direct carbonation of activated lizardite: The identification a poorly reactive amorphous Mg-rich silicate phase, Int. J. Greenh. Gas Control. 100 (2020) 103114. https://doi.org/10.1016/j.ijggc.2020.103114.
[17] Quaghebeur, M., Laenen, B., Nielsen, P., Production of a mainly carbonate bonded article by carbonation of alkaline materials, CA2722724, 2017.
[18] Centre National de la Recherche Scientifique, Magnesite and hydromagnesite preparation process, EP 2 692 691 A1, 2014.
[19] Blencoe, James G., Palmer, Donald A, Anovitz, Lawrence M, Beard, James S, Carbonation of metal silicates for long-term CO₂ sequestration, U.S. Pat. No. 8,673,256 B2, 2012.
[20] USGS, Mineral Commodity Summaries, 2018.
[21] S. Wietlisbach, Minerals production, market consumption drivers, new projects and forecast, (2018).

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While specific embodiments of the subject invention have been discussed, the above specification is illustrative and not restrictive. Many variations of the invention will become apparent to those skilled in the art upon review of this specification and the claims below. The full scope of the invention should be determined by reference to the claims, along with their full scope of equivalents, and the specification, along with such variations.

We claim:

1. A method of preparing a concrete product, comprising:
(a) forming a concrete mixture into a desired shape; and
(b) cementing and carbonating the concrete mixture through contact with a gaseous CO₂ source,
wherein the concrete mixture comprises:
(i) 5-50% (w/w) of a cementitious precursor comprising:
(a) from about 20% to about 90% (w/w) of a binder comprising brucite and a cement replacement material; and
(b) from about 5% to about 80% (w/w) Ordinary Portland Cement; and
(ii) 50-95% (w/w) of a filler.

2. The method of claim 1, wherein the concrete mixture is cemented and carbonated at a curing temperature from about 20 to about 90° C.

3. (canceled)

4. The method of claim 1, wherein the concrete mixture is cemented and carbonated at a relative humidity of between about 10 and 100%.

5. (canceled)

6. (canceled)

7. The method of claim 1, wherein the concrete mixture is cemented and carbonated at a CO₂ concentration from about 2 to about 30% (v/v).

8. (canceled)

9. The method of claim 1, wherein the concrete mixture is carbonated at a carbonation pressure from about 0.01 to about 1.0 MPa.

10. The method of claim 1, wherein the filler comprises an aggregate material, wherein the aggregate material comprises gravel, sand, pebbles, crushed stones, crushed recycled concrete, rocks, slag, bottom ash, or any combination thereof.

11. (canceled)

12. The method of claim 1, wherein the cement replacement material comprises fly ash, slag cement, recycled cement, ground steel slag, or any combination thereof.

13. The method of claim 1, wherein the concrete mixture further comprises an admixture, wherein the admixture comprises a water reducing admixture, a retarding admixture, an accelerating admixture, an air entraining concrete admixture, a pozzolanic admixture, a damp-proofing admixture, a gas forming admixture, an air detraining admixture, an alkali aggregate expansion admixture, an inhibiting admixture, an anti-washout admixture, a grouting admixture, a corrosion inhibiting admixture, a bonding admixture, a fungicidal admixture, a germicidal admixture, an insecticidal admixture, a coloring admixture, or any combination thereof.

14. (canceled)

15. The method of claim 1, wherein the cementitious precursor comprises about 20% to about 80% (w/w) of the binder.

16. The method of claim 1, wherein the cementitious precursor comprises from about 60% to about 80% (w/w) brucite.

17. The method of claim 1, wherein the cementitious precursor comprises about 5% to about 50% (w/w) Ordinary Portland Cement.

18. The method of claim 1, wherein the brucite has a purity from about 30% to 100%.

19. A concrete mixture composition comprising:
(i) 5-50% (w/w) of cementitious precursor comprising:
(a) from about 20% to about 90% (w/w) of a binder comprising brucite and a cement replacement material; and
(b) from about 5% to about 80% (w/w) Ordinary Portland Cement; and
(ii) 50-95% (w/w) of filler.

20. The composition of claim 19, wherein the filler comprises gravel, sand, pebbles, crushed stones, crushed recycled concrete or fill, rocks, slag, bottom ash, or any combination thereof.

21. The composition of claim 19, wherein the cement replacement material comprises fly ash, slag cement, recycled cement, and ground steel slag.

22. The composition of claim 19, further comprising an admixture, wherein the admixture comprises a water reducing admixture, a retarding admixture, an accelerating admixture, an air entraining concrete admixture, a pozzolanic admixture, a damp-proofing admixture, a gas forming admixture, an air detraining admixture, an alkali aggregate expansion admixture, an inhibiting admixture, an anti-washout admixture, a grouting admixture, a corrosion inhibiting admixture, a bonding admixture, a fungicidal admixture, a germicidal admixture, an insecticidal admixture, a coloring admixture, or any combination thereof.

23. (canceled)

24. The composition of claim 19, wherein the cementitious precursor comprises about 20% to about 80% (w/w) of the binder.

25. The composition of claim 19, wherein the cementitious precursor comprises about 5% to about 50% (w/w) Ordinary Portland Cement.

26. The composition of claim 19, wherein the cementitious precursor comprises from about 60% to about 80% (w/w) brucite.

27. The composition of claim 19, wherein the brucite has a purity from about 30% to 100%.
